(19) United States
(12) Patent Application Publication
(10) Pub. No.: US 2026/0299803 A1
(43) Pub. Date: Oct. 1, 2026

(54) LOW POWER MANAGEMENT AND CLOCK MANAGEMENT WITHIN A MULTI-PORT MEMORY SYSTEM

(71) Applicant: Micron Technology, Inc., Boise, ID (US)

(72) Inventors: John E. Maroney, Irvine, CA (US); Pedro Cordon, Irvine, CA (US)

(21) Appl. No.: 19/578,684

(22) Filed: Mar. 25, 2026

Related U.S. Application Data
(60) Provisional application No. 63/781,818, filed on Apr. 1, 2025.

(51) Int. Cl. G06F 3/06

(52) U.S. Cl. CPC G06F 3/0625; G06F 3/0655; G06F 3/0673

(57) ABSTRACT

Methods, systems, and devices for low power management and clock management within a multi-port memory system are described. A memory system may support clock management and power management across multiple ports within the memory system. The memory system may perform power management on a per-port basis according to a set of power state transition rules and protocols. The memory system may receive a configuration for operation of the ports according to a set of link states. The memory system may perform clock management by receiving signaling that indicates a clocking configuration across the set of ports. The clocking configuration may be for a common reference clock for each port, or for separate reference clocks used independently by each port. The memory system may exchange signaling with two or more host systems via two or more ports of the set of ports in accordance with the clocking configuration.

### CROSS REFERENCE

The present Application for Patent claims priority to U.S. Patent Application No. 63/781,818 by Maroney et al., entitled “LOW POWER MANAGEMENT AND CLOCK MANAGEMENT WITHIN A MULTI-PORT MEMORY SYSTEM,” filed Apr. 1, 2025, which is assigned to the assignee hereof, and which is expressly incorporated by reference in its entirety herein.

### TECHNICAL FIELD

The following relates to one or more systems for memory, including low power management and clock management within a multi-port memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports low power management and clock management within a multi-port memory system in accordance with examples as disclosed herein.

FIG. 2 shows an example of an architecture that supports low power management and clock management within a multi-port memory system in accordance with examples as disclosed herein.

FIG. 3 shows an example of a link state diagram that supports low power management and clock management within a multi-port memory system in accordance with examples as disclosed herein.

FIG. 4 shows an example of an input-output diagram that supports low power management and clock management within a multi-port memory system in accordance with examples as disclosed herein.

FIG. 5 shows a block diagram of a memory system that supports low power management and clock management within a multi-port memory system in accordance with examples as disclosed herein.

FIGS. 6 and 7 show flowcharts illustrating a method or methods that support low power management and clock management within a multi-port memory system in accordance with examples as disclosed herein.

### DETAILED DESCRIPTION

Some memory systems may operate using a single port and corresponding interface with a single host system. For example, some memory systems (e.g., solid state drives (SSDs)) may be single ported. These memory systems may lack a strategy or topology for multiple hosts to interact with the memory system. Some memory systems (e.g., automotive systems) may include more than one port for interactions with multiple host systems, but some such multi-ported memory systems may lack effective solutions for management of clocks and/or power states across the multiple ports. Techniques for power and clock management for multi-port memory systems, including quad-port memory systems, may be beneficial.

Techniques described herein support clock management and power management across multiple ports within a memory system (e.g., a multi-port memory system, a quad port memory system). Power management may be performed on a subset of total ports, such as a per-port basis, according to a set of power state transition rules and protocols. For example, the memory system may receive a configuration for operation of the ports according to a set of link states. A link state may represent a state of a link between a port and a corresponding host system, including whether the link is operational (or non-operational), a power level associated with the link, a data rate associated with the link, a clock configuration of the link, and the like. The memory system may transition one or more ports, such as each port, to a respective second link state in response to a management command from a host system or autonomously in accordance with an autonomous power state transition sequence and an idle time of the ports. In some examples, one or more ports may be in respective different link states than other ports at a given time, or all of the ports may be in a same link state at a given time. Accordingly, the memory system may perform power management on a per-port basis by coordinating link states of the set of ports.

To perform clock management, the memory system may receive signaling that indicates a clocking configuration across the set of ports. The clocking configuration may enable a common reference clock for use by each port, or may enable separate reference clocks used independently by each port. The memory system may exchange signaling with two or more host systems via two or more ports of the set of ports in accordance with the clocking configuration. To switch two or more ports to different link states, the memory system may either disable the common reference clock or check that separate reference clocks are used, which may allow each port and corresponding link to be operated with a reduced data speed, or different operational states, or the like.

In addition to applicability in memory systems as described herein, techniques for low power management and clock management within a multi-port memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by allowing ports of a multi-port device to operate according to a shared reference clock or multiple separate reference clocks depending on device needs and implementation, which may improve flexibility and performance of each port on the multi-port device and may reduce a cost of systems (e.g., phase-locked loop (PLL) systems). These techniques may also accommodate systems that cannot support separate reference clocks with independent spread spectrum clocking (SRIS) for each port, among other benefits.

In addition to applicability in memory systems as described herein, techniques for low power management and clock management within a multi-port memory system may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by managing power according to device commands and behavior for multi-port devices, including automatically transitioning to low power states based on idle state of ports, which may improve sustainability by decreasing a total power usage to operate these devices, among other benefits.

Features of the disclosure are illustrated and described in the context of systems, devices, and circuits. Features of the disclosure are further illustrated and described in the context of an architecture, a link state diagram, an input-output diagram, and flowcharts.

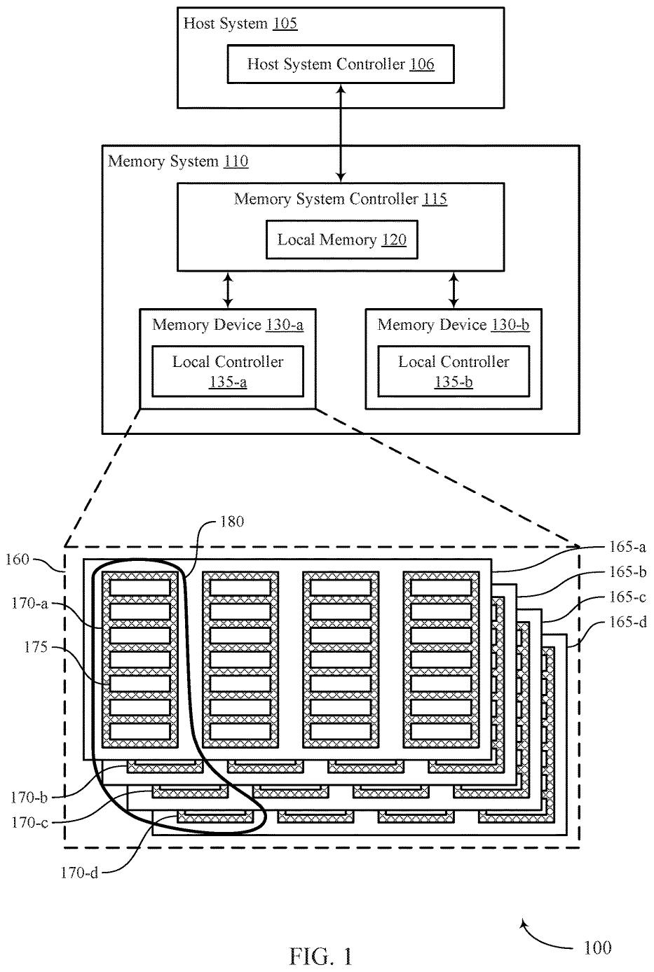

FIG. 1 shows an example of a system 100 that supports low power management and clock management within a multi-port memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, an SSD, a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

Some systems may operate with a single port (e.g., single ported automotive SSDs). These systems may lack a strategy or topology for multiple host systems to control power management, clock management, or both. Such systems may be inhibited from the benefits of multiple host control. For example, a single-ported system (e.g., an automotive SSD) may support power control management using the single port of the single-ported system. Similarly, the single-ported system may support a reference clock signal on the single port, but may not support multi-port clock signals, SRIS, or the like. Accordingly, techniques described herein may support multiple port systems, where multiple hosts may control power control management and clock management (e.g., both dual port and quad port systems).

In some cases, the memory system 110 may support active state power management (ASPM). ASPM may refer to an autonomous, hardware-based, active state mechanism that may enable power savings. After a period of idle link time (e.g., at one or more ports of the memory system 110), an ASPM physical-payer protocol may include placing idle links (and corresponding ports) into a lower power state. Once in the lower power state, the memory system 110 may transition one or more idle links to a fully operative state (e.g., an L0 state) in response to detecting traffic on either side of each idle link. In some examples, the memory system 110 (or a host system 105) may disable ASPM (e.g., via a software command). If a port is operating according to an idle state (e.g., ASPM L1.0) and if a non-operational enable bit associated with the port (e.g., an ASPM L1.2 enable bit) is set, the port may enter a corresponding non-operational sub-state (e.g., L1.2) in response to a clock request signal (e.g., CLK REQ #) being de-asserted. If the port is operating according to the idle state and if a different non-operational enable bit associated with the port (e.g., an ASPM L1.1 enable bit) is set, the port may enter a non-operational sub-state (e.g., L1.1) associated with the different non-operational enable bit in response to the clock request signal being de-asserted.

In some cases, the memory system 110 may support one or more control commands (e.g., PCIe mode control commands) such as get and set commands. The one or more control commands may control enabling and disabling a reference clock (e.g., REFCLK). In some examples, the one or more control commands may control spread spectrum clocking (SSC) for enabling and disabling SRIS or for enabling and disabling separate reference clock with no SSC (SRNS). Additionally, or alternatively, the one or more control commands may control a termination of a reference clock, a threshold speed lane and width (e.g., host initiated maximum speed and lane width), or both. As described herein, SSC may refer to a technique for reducing an amount of interference (e.g., electromagnetic interference) produced by a clock signal. Applying SSC may include slightly modulating a clock's frequency to spread an energy of the clock signal over a relatively wide range of frequencies. Accordingly, SRIS may refer to applying SSC to a reference clock that is separate from other reference clocks such as a common (or shared) reference clock.

The system 100 may support clock management and power management across multiple ports within a memory system 110. The memory system 110 may be an example of a multi-port memory system, a quad port memory system, or the like. A device (e.g., a host system 105, the memory system 110, or both) may perform power management on a per-port basis according to one or more power state transition rules or protocols. For example, the memory system 110 may receive a configuration for operation of the ports according to a set of link states. As used herein, the term “link state” may refer to a state of a link between a port of the memory system 110 and a host system 105. A link state may indicate whether the link is operational, a power level associated with the link, a data rate associated with the link, a clock configuration associated with the link, or any combination thereof.

The memory system 110 may transition each port of a set of ports from a respective first link state to a respective second link state. In some cases, this transition may be in response to a management command from a host system 105. Additionally, or alternatively, the memory system 110 may perform the transition autonomously in accordance with an autonomous power state transition sequence and an idle duration of the ports. In some examples, one or more ports of the set of ports may be in different link states than other ports of the set of ports. Additionally, or alternatively, all of the ports may be in a same link state at a particular time instance. Accordingly, the memory system 110 may perform power management on a per-port basis by coordinating link states of the set of ports.

Further, the memory system 110 may support clock management using the set of ports. For example, the memory system 110 may receive signaling that indicates a clocking configuration across the set of ports. As described herein, the term “clocking configuration” may refer to a configuration that includes one or more clocking parameters (e.g., a type of clock to be used per port, whether a same clock may be used). For example, the clocking configuration may be for a common reference clock to be enabled and used by each port. Additionally, or alternatively, the clocking configuration may be for separate reference clocks used independently by each port. The memory system 110 may exchange signaling with two or more host systems 105 via two or more ports of the set of ports based on the clocking configuration. To switch two or more ports to respective (e.g., different) link states, the memory system 110 may disable the common reference clock. Additionally, or alternatively, the memory system 110 may determine that separate reference clocks are used for each port of the two or more ports. Such separate reference clocks may allow each port and each corresponding link to be operated with a reduced data speed, with different operational states, or the like.

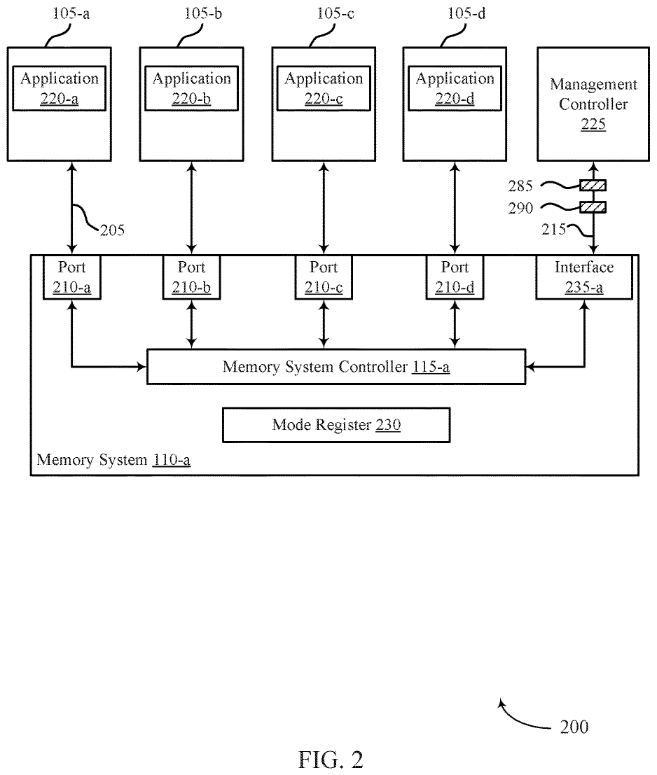

FIG. 2 shows an example of an architecture 200 that supports low power management and clock management within a multi-port memory system in accordance with examples as disclosed herein. One or more aspects of the architecture 200 may implement or may be implemented by one or more aspects of the system 100. For example, the architecture 200 may include a host system 105-a, a host system 105-b, a host system 105-c, a host system 105-d, and a memory system 110-a with a memory system controller 115-a and a mode register 230, which may be examples of corresponding devices or systems described herein. In some cases, the architecture 200 may be implemented in or as part of an automotive system, and architecture 200 may support increased performance, reliability, and sustainability for memory systems included within the automative system as described herein.

For example, memory system 110-a may be a multi-ported memory system and may include a port 210-a, a port 210-b, a port 210-c, and a port 210-d. The ports 210 may allow for multiple host systems 105 to establish connections with the memory system 110-a and to execute commands using the memory system 110-a for executing applications 220 (e.g., or functions). For example, a host system 105-a may be coupled with the memory system 110-a via the port 210-a and may host (e.g., and may execute commands for) an application 220-a. A host system 105-b may be coupled with the memory system 110-a via the port 210-b and may host an application 220-b, a host system 105-c may be coupled with the memory system via the memory system 110-a via the port 210-c and may host an application 220-c, and a host system 105-d may be coupled with the memory system 110-a via the port 210-d and may host an application 220-d. In some examples, each port 210 may operate independently. For example, each port 210 may involve different link speeds (e.g., PCIe link speeds) or may be reset independently. Further, the ports 210 may operate simultaneously or concurrently, or at different times. In some cases, boot partitions, replay protected memory blocks (RPMBs), virtualization (e.g., single root I/O virtualization (SRIOV)), and resource allocation may also be per port.

Although the architecture 200 illustrates four host systems 105 and four ports 210, it is to be understood that a memory system may include any quantity and combination of ports and host systems, including four of each, or any other quantities. The memory system 110-a may include one or more memory arrays across one or more memory devices that store data for the execution of the various applications. The ports may provide an interface for communicating commands and data with the host systems 105, but the actual data for each host system 105 may be stored in various locations within the memory system 110-a.

In some examples, the host systems 105 may transmit commands (e.g., in-band commands) that are associated with execution of an application 220. The host systems 105 may be controlled by or may include one or more components or systems of an automotive platform, and applications 220 may support one or more functions of the automotive platform or some other type of platform. Such commands may be communicated to the memory system 110-a via a peripheral component interconnect (PCI) interface 205 between a host system 105 and a port 210 of the memory system 110-a, which may be referred to as an in-band channel. The host systems 105 may communicate with the memory system 110-a using the ports 210 via in-band signaling (e.g., via a PCIe bus) which may differ from out-of-band (OOB) signaling, as the PCI interface 205 may support transfer of data and commands, while one or more OOB channels may not be used for data transfer, but may instead be used for transfer of metadata and other management commands. Commands sent by a host system 105 may cause or instruct the memory system controller 115-a to execute operations and/or access memory (e.g., at one or more memory devices 130 of the memory system 110-a). The commands may be non-volatile memory express (NVMe) commands, or some other type of command.

In some examples, the memory system 110-a may include an interface 235-a (e.g., a management port, a management end point) which may be used for managing one or more aspects of the memory system 110-a. In some cases, the memory system 110-a may use the interface 235-a and the ports 210 for power management and clock management (e.g., via one or more channels 215). For example, the memory system 110 a may receive, from a management controller 225, one or more power and/or clock management commands or other configurations. In some implementations, for each port 210 to communicate with a respective host system 105 via a respective PCI interface 205, each port 210 may include at least one physical function (PF) miniport driver and a set of virtual function (VF) miniport drivers. The at least one PF miniport driver may communicate with a management driver of the respective host system 105 and each of the set of VFs may communicate with a respective driver of the respective host system 105. In some examples, the interface 235-a (e.g., the management port) may communicate with a management driver of at least one host system 105 (e.g., the host system 105-a). For example, the at least one host system 105 may include a management controller that includes the management driver in communication with the interface 235-a.

The architecture 200 may support clock management and power management across the ports 210 associated with the memory system 110-a. In some cases, by managing clocking and power of the memory system 110-a, a memory system 110-a may have a longer device life and increased overall performance, when compared with other memory systems. A system (e.g., the memory system in combination with the host systems 105) may perform power management on a per-port basis according to one or more power state transition rules or protocols. For example, the memory system 110-a may receive a configuration 285 for operation of the ports 210 according to a set of link states (e.g., via the interface 235-a). The configuration 285 may indicate, for each link state of the set, whether a corresponding link is operational, a power level associated with the corresponding link, a data rate associated with the corresponding link, a clock configuration associated with the corresponding link, or any combination thereof.

The memory system 110-a may transition each port 210 from a respective first link state to a respective second link state. In some cases, this transition may be in response to a management command 290 from a host system 105. As described herein, the term “management command” (e.g., the management command 290) may refer to a command (e.g., an NVMe command from a host system 105) that configures one or more settings of a device (e.g., a memory system 110). Additionally, or alternatively, the memory system 110-a may perform the transition autonomously in accordance with an autonomous power state transition sequence and an idle state duration of the ports 210. In some examples, one or more ports 210 may be in different link states than other ports 210. For example, the port 210-a and the port 210-b may be in a first link state while the port 210-c and the port 210-d may be in a second link state. Additionally, or alternatively, each port 210 may be in a same link state at a particular time. Accordingly, the memory system 110-a may perform power management on a per-port basis by coordinating link states of the ports 210.

Further, the memory system 110-a may support clock management using the ports 210. For example, the memory system 110-a may receive signaling that indicates a clocking configuration across the ports 210. The clocking configuration may be for a common reference clock to be enabled and used by each port 210. Additionally, or alternatively, the clocking configuration may be for separate reference clocks used independently by each port 210. The memory system 110-a may exchange signaling with two or more host systems 105 via two or more ports 210 of the set of ports based on the clocking configuration. To switch two or more ports 210 to respective (e.g., different) link states, the memory system 110-a may disable the common reference clock. Additionally, or alternatively, the memory system 110-a may determine that separate reference clocks are used for each port 210. Such separate reference clocks may allow each port 210 and each corresponding link to be operated with a reduced data speed, with different operational states, or the like.

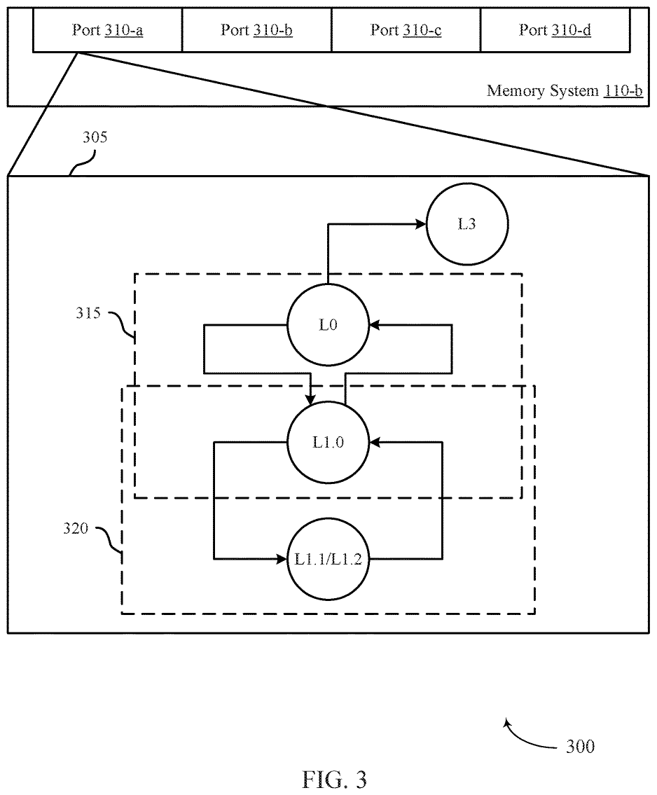

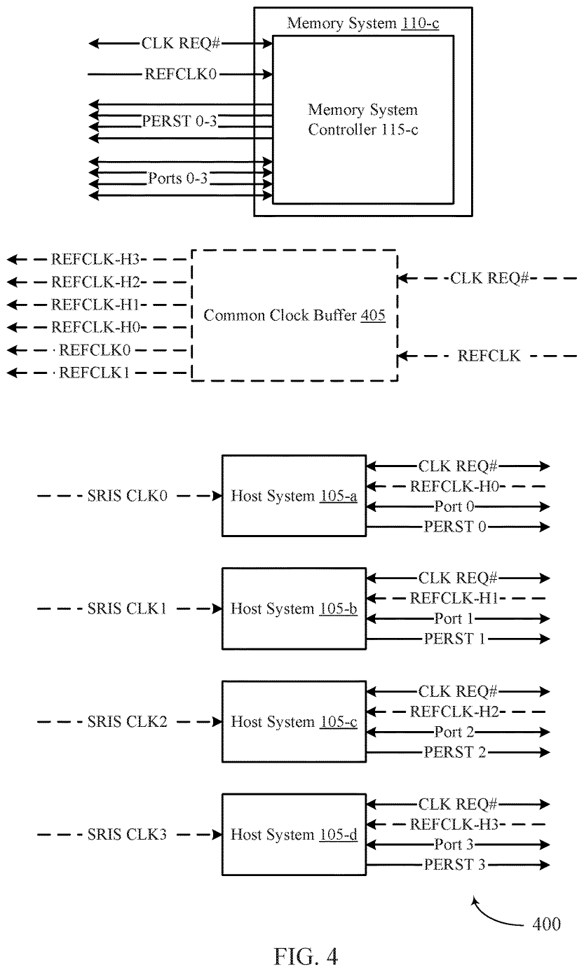

In some examples, the memory system 110-a may store data for applications associated with relatively high reliability and performance requirements, such as a vehicle or other automated system. In such cases, power and clock management at a multi-ported system may reduce a likelihood of system failure and electronic waste. Techniques for power management and clock management within a multi-ported memory system are described in further detail elsewhere herein, including with reference to FIGS. 3 and 4.

FIG. 3 shows an example of a link state diagram 300 that supports low power management and clock management within a multi-port memory system in accordance with examples as disclosed herein. The link state diagram 300 may implement or be implemented by one or more aspects as described herein with reference to FIGS. 1 and 2. For example, the link state diagram 300 includes a memory system 110-b that may be in communication with one or more host systems 105 (not pictured in FIG. 3), which may be examples of the corresponding devices as described herein. The link state diagram 300 also includes a state transition diagram 305. The state transition diagram 305 illustrates a transition capability of link states corresponding to ports 310 of the memory system 110-b. In some cases, the memory system 110-b may be a multi-ported memory system including the ports 310 (e.g., a port 310-a, a port 310-b, a port 310-c, a port 310-d). The memory system 110-b may communicate with a respective host system 105 via each port 310. That is, each port 310 may be configured for communication via a respective link, as described with reference to FIG. 2. Accordingly, each port 310 of the memory system 110-b may operate according to a respective link state as illustrated by the state transition diagram 305. As described herein, a port 310 being “in” a particular link state may indicate that the port 310 operates or is operating according to the particular link state.

The memory system 110-b may operate each port 310 in a respective link state according to the state transition diagram 305. For example, the port 310-a may be in a link state L0 (e.g., an active link state or a full power state), a link state L1.0 (e.g., a throttled or idle link state), a link state L1.1 (e.g., an inactive state, a non-operational link state, or a low power state), a link state L3 (e.g., an “off” or “cold” link state, a “no power” state), or the like. The link state L0 and the link state L1.0 may correspond to a first operation state 315 (e.g., an operational state). As described herein, an “operation state” may refer to a type of operation corresponding to a link state or a power state (e.g., operational or non-operational). For example, the first operation state may be or may include one or more operational power states (e.g., PS0, PS1, PS2, throttle power state) and may be referred to as an “operational” state. Similarly, the link state L1.0, the link state L1.1, and the link state L1.2 may correspond to a second operation state 320 (e.g., a non-operational state). The second operation state may be or may include one or more non-operational power states (e.g., PS3, PS4) and may be referred to as a “non-operational” state. Each link state corresponding to the second operation state 320 may be associated with a disabled reference clock and a disabled SRIS. In some cases, the link state L1.0 (e.g., the idle link state) may be correspond to the first operation state 315, the second operation state 320, or both. The link state L3 may correspond to a third operation state (e.g., an “off” power state).

The memory system 110-b may transition each port 310 from the respective link state to a respective second link state. In some cases, a port 310 may move from any link state described herein to another link state described herein. Accordingly, the state transition diagram 305 illustrates one example of a transitioning protocol or scheme for link states. For example, if the port 310-a is in the link state L0, the memory system 110-b may transition the port 310-a to the link state L1.0 (e.g., if the port 310-a is idle) or to the link state L3. Similarly, if the port 310-a is in the link state L1.0, the memory system 110-b may transition the port 310-a to the link state L0 (e.g., if the link is no longer idle) or to the link state L1.1 (or to the link state L1.2, or another non-operational link state). In some cases, the memory system 110-b may transition the port 310-a to the link state L1.1 (or the like) in accordance with de-asserting a clock request signal (e.g., CLK REQ #, as described with reference to FIG. 4). If the port 310-a is in the link state L1.1 (or the link state L1.2, or another non-operational link state), the memory system 110-b may transition the port 310-a to the link state L1.0. In some cases, the memory system 110-b may transition the port 310-a to the link state L1.0 in accordance with asserting (or re-asserting) the clock request signal. In some examples, a port 310-a may transition to the link state L3 (e.g., the “off” link state) from any other link state (e.g., power management event (PME) turn off). Although four link states are illustrated in FIG. 3, it is to be understood that a memory system 110-b may operate according to (and transition between) any quantity of link states, including the example link states illustrated in FIG. 3, or other link states associated with various other example power levels, clock speeds, and the like.

In some implementations, the memory system 110-b may perform multi-port power management (e.g., quad port power management), including low power management (LPM). For example, the memory system 110-b may receive a configuration for operation of the ports 310 according to the link states as described herein. The memory system 110-b may receive the configuration via a management command such as a host power NVMe management command (e.g., PS1, PS2, PS3, PS4). The management command may indicate a power state for at least some of the ports 310. In some cases, the memory system 110-b may transition some of the ports 310 based on the power state indicated in the management command.

The memory system 110-b may receive the management command on a management port of the memory system 110-b via a management strategy (e.g., set by a “set all port” command). In some examples, the ports 310 (e.g., all ports) may coordinate power management for a sub-system (e.g., by the management port) to transition the entire subsystem to an LPM mode. Additionally, or alternatively, one or more ports 310 may transition to the LPM mode according to one or more rules. For example, as depicted in Table 1, the memory system 110-b may support the link states described herein for one or more ports (e.g., single, dual, triple, and quad ports) with one or more NVMe power states (e.g., PS0, PS1, PS2, PS3, PS4). Table 1 provides some example parameters and settings associated with each of the four link states illustrated in FIG. 3. For example, Table 1 includes example PCIe data speeds, port reset quantities, reference clock and/or SRIS configurations, power domains, thermal throttling limitations, power state limitations across ports, power off state limitations across ports, and varying power state limitations across ports associated with each of the link states L0, L1.0, L1.2, and L3. It is to be understood that these are merely examples, and a memory system may support any quantity of various link states each associated with any quantity or combination of varying operational parameters.

TABLE 1
Independence Level of Operation per Power and Link State

| Attribute | L0 | L1.0 | L1.2 | L3 |
|---|---|---|---|---|
| Speed (PCIe | All Ports can operate | All Ports can operate | NA | NA |
| GEN4/3/2/1) | with Independent | with Independent | | |
| | PCIe Gen speeds in | PCIe Gen speeds in | | |
| | this link state | L1.0 state | | |
| PERST# (port reset) | Any port can reset | Any port can reset | Any port can reset | Any port can reset |
| | independently | independently | independently | independently |
| REFCLK (reference | shared REFCLK with | shared REFCLK with | No REFCLK with | No REFCLK with |
| clock) | shared CLK REQ# | shared CLK REQ# | shared CLK REQ# | shared CLK REQ# |
| | asserted | asserted | de-asserted | de-asserted |
| SRIS | SRIS with shared | SRIS with shared | No SRIS with shared | No SRIS with shared |
| | CLK REQ# asserted | CLK REQ# asserted | CLK REQ# de-asserted | CLK REQ# de-asserted |
| Power domains | Single power domain | Single power domain | Single power domain | Single power domain |
| PS0/PS1/PS2 or | All enter/exit same | NA | NA | NA |
| thermal throttle states | time | | | |
| PS4 or PS3 | Other ports can | Other ports can | All ports may | Other ports can |
| | operate in this link | operate in this link | enter/exit same time | operate in this link |
| | state. | state. | with L1.2 link state | state. |
| Single Host port in | Other ports can | Other ports can | Link state not | This is the port Link |
| power off state | operate in this link | operate in this link | allowed | state for power |
| | state. | state. | | off = L3 |
| Device port in L0 | Other ports can | Other ports can | Link state not | Other ports can |
| link state | operate in this link | operate in this link | allowed | operate in this link |
| | state. | state. | | state. |
| Device port in L1.0 | Other ports can | Other ports can | Link state not | Other ports can |
| link state | operate in this link | operate in this link | allowed | operate in this link |
| | state. | state | | state. |
| Device port in L1.2 | Link state not | Link state not | All ports may | Link state not |
| link state | allowed | allowed | enter/exit same time | allowed |
| | | | with L1.2 link state | |
| Device port in L3 | Other ports can | Other ports can | Link state not | Other ports can |
| link state | operate in this link | operate in this link | allowed | operate in this link |
| | state. | state. | | state. |

In some cases, the memory system 110-b may perform NVMe autonomous power state transition (APST). For example, the memory system 110-b may periodically perform link state transitions at each port 310 in accordance with an APST sequence. In some implementations, the memory system 110-b may transition at least one port 310 (e.g., automatically) to the LPM mode (e.g., a non-operational power state, PS3 or PS4) based on an idle time associated with the at least one port 310 (e.g., in accordance with the APST sequence). For example, if each port 310 has a respective idle time that satisfies (e.g., exceeds) a threshold, the memory system 110-b may transition to the non-operational power state.

In some implementations, each port 310 may be associated with a respective processing component (e.g., a system on chip (SOC)). Each processing component on each port 310 may be powered on or off independently. For example, the memory system 110-b may control a power state of each processing component of each port 310 (e.g., powering each processing component on or off) via a link management procedure. For instance, in response to receiving a first command to disable power management for the port 310-a, the memory system 110-b may set the port 310-a to the link state L3 (e.g., an “off” state, or a “D3 cold” state). That is, the link state L3 may refer to a link state associated with disabled power management. Then, in response to receiving a second command to re-enable power management for the port 310-a, the memory system 110-b may set the port 310-a to the link state L0 (e.g., an “on” state, or a reenabled power management state). Accordingly, the memory system 110-b may perform port management for any of the ports 310 or for a system management bus (SMBus).

In some implementations, the ports 310 of the memory system 110-b may operate in respective link states according to a link state configuration. For example, in some cases, the link state configuration may indicate that each port 310 is to operate according to a same operation state (e.g., operational or non-operational). In such cases, all of the ports 310 may operate in a same link state (e.g., the link state L0). Similarly, one or more of the ports 310 (e.g., the port 310-a and the port 310-b) may operate in the link state L0, and one or more others of the ports 310 (e.g., the port 310-c and the port 310-d) may operate in the link state L1.0 (e.g., the idle state may correspond to an operational state). Additionally, or alternatively, each port 310 may operate in a respective link state corresponding to a non-operational power state (e.g., all ports 310 may operate in one of the link states L1.2, L1.1, or L1.0).

In some examples, one port 310 (e.g., the port 310-a) may operate in the link state L3 (e.g., the port 310-a may be off) while other ports 310 (e.g., the port 310-b, the port 310-c, and the port 310-d) may each operate in a respective link state corresponding to the first operation state (e.g., an “operational” state). That is, the link state L3 may be considered an operational for the purposes of the link state configuration. Similarly, the link state configuration may apply for ports 310 that are not in the link state L3 (e.g., in the “off” state). In some cases, the link state configuration may indicate that each port 310 may operate according to a respective link state regardless of operation state. In some other cases, the memory system 110-b may prohibit (e.g., disallow, disable) a link state configuration in which one or more ports 310 are in the link state L3 and one or more other ports 310 are in a link state corresponding to a non-operational state (e.g., L1.2, L1.1). Similarly, the memory system 110-b may prohibit a link state configuration in which one or more ports 310 are in an operational link state (e.g., L0, L1.0) and one or more other ports 310 are in a link state corresponding to a non-operational state (e.g., L1.2, L1.1).

In some cases, by applying the techniques for multi-port power management as described herein, the memory system 110-b may support one or more technical advantages. For example, each port 310 of the memory system 110-b may be powered down or at an idle link state (e.g., L1.0). Each port may accept (e.g., as designated by a management port) power management commands (e.g., NVMe power management commands) from a host system for one or more power state levels (e.g., PS0 through PS4). The memory system 110 may also support NVMe APST, transitioning the memory system 110 automatically to a low power mode (e.g., PS3 or PS4 states) based on an idle time on the ports 310. Accordingly, the memory system 110 may have a reduced power consumption when compared with other devices, thus increasing efficiency.

FIG. 4 shows an example of an input-output diagram 400 that supports low power management and clock management within a multi-port memory system in accordance with examples as disclosed herein. The input-output diagram 400 may implement or be implemented by one or more aspects as described herein with reference to FIGS. 1, 2, and 3. For example, the input-output diagram 400 includes a memory system 110-c in communication with one or more host systems 105 (e.g., a host system 105-a, a host system 105-b, a host system 105-c, a host system 105-d), which may be examples of the corresponding devices as described herein. The memory system 110-c includes a memory system controller 115-c, which may execute one or more operations described herein to be performed by the memory system 110-c. The input-output diagram 400 also illustrates some components optionally included in the memory system 110-c, such as a common clock buffer 405, implemented for one or more aspects as described herein. Each host system 105 may couple with the memory system 110-c (e.g., although different quantities of inputs and outputs may be shown in the input-output diagram 400).

In some implementations, each port of the memory system 110-c may share a reference clock. For example, the ports of the memory system 110-c may support a shared reference clock with spread spectrum. In some cases, for the shared reference clock, each host system 105 may transmit (e.g., provide, supply) a buffered source signal from a same clock domain. In some implementations, if the memory system 110-c uses a shared clock signal (e.g., a common clock signal), the memory system 110-c may enter a sub-state (e.g., a low power link state) based on one or more conditions. For example, each respective host system 105 corresponding to each port of the memory system 110-c may set (e.g., configure, transmit) a link state request separately (e.g., from other host systems 105). In some cases, each host system 105 may set a respective port in a same sub-state (e.g., as described with reference to FIG. 3). Accordingly, the memory system 110-c may detect that all ports meet the condition to enter the sub-state. In response, the memory system 110-c may de-assert the shared clock signal and may enter the sub-state.

In some implementations, the memory system 110-c may use a respective SRIS for each port (e.g., based on an absence of the shared reference clock or an SRIS configuration, or both). For example, each port of the memory system 110-c may be supported via the respective SRIS. In some cases, in accordance with each port operating using a respective SRIS, the host systems 105 may operate according to different (e.g., separate) clock domains (e.g., based on the host systems 105 having different system topologies). In some examples, if one or more of the host systems 105 associated with the ports do not support SRIS, the memory system 110-c may use a shared clock signal configuration for the ports, as described herein.

The memory system 110-c may perform clock management (e.g., quad-port clock management) to manage or set an interface timing (e.g., a PCIe bus interface timing) of the memory system 110-c on each port. The memory system 110-c may apply one or more methods to perform clock management. In accordance with a first method, the memory system 110-c may use a REFCLK signal corresponding to an out of band differential clock source (e.g., at 100 MHz). In accordance with a second method, the memory system 110-c may use an SRIS for each port of the memory system 110-c. An SRIS may be an in-band embedded link clock in a PCIe interface of the memory system 110-c (e.g., each port may have an individual, embedded SRIS). The memory system 110-c may determine whether to use the first method or the second method based on one or more parameters associated with a system implementation of the memory system 110-c. In some cases, the memory system 110-c may support SRIS for multiple port configurations (e.g., single port, dual port, triple port, and quad port). Each port of the memory system 110-c may operate independently. Accordingly, if one port (e.g., port 0) of the memory system 110-c fails, the memory system 110-c may reset the port and may clear outstanding operations associated with the port.

In some implementations, the host systems 105 may support one or more PCIe mode control commands (e.g., administration commands, get and set PCIe mode control commands). Accordingly, a host system 105 (e.g., the host system 105-a or another host system as described herein) may control one or more clock management modes and features. A manufacturing data portion of the memory system 110-c may be or may include a plan of record (POR) of the memory system 110-c. Accordingly, the host system 105 may modify the manufacturing data portion (e.g., the POR) to control the one or more clock management modes and features. In the following description, controlling (e.g., enabling or disabling) features at the POR may include writing or modifying data at the manufacturing data portion of the memory system 110-c.

In some examples, the host system 105 may control an autodetect REFCLK feature. For example, if the memory system 110-c is using SRIS, the host system 105 may disable an automatic REFCLK detection feature at the POR of the memory system 110-c. In some cases, the host system 105 may enable or disable SSC for SRIS or SRNS. For example, the host system 105 may disable an SSC feature at the POR of the memory system 110-c (e.g., if the memory system 110-c is using SRIS or SRNS). Additionally, or alternatively, the host system 105 may control a REFCLK termination feature. For example, the host system 105 may disable internal termination at the POR of the memory system 110-c (e.g., if REFCLK termination is external to a BGA associated with the memory system 110-c). In some implementations, the host system 105 may support setting a threshold speed or lane width (e.g., a host-initiated maximum speed/lane width) associated with clock management for the memory system 110-c. For example, the host system 105 may set a threshold (e.g., a maximum) speed if the memory system 110-c does not support a speed associated with a particular generation (e.g., if the memory system 110-c prevents GEN4).

The memory system 110-c may support a first configuration (e.g., a quad port common REFCLK clock management topology, a “REFCLK only” clock topology, or a “common clock” topology) that includes the common clock buffer 405. Additionally, or alternatively, the memory system 110-c may support a second configuration (e.g., a quad port independent SRIS/NS clock management topology, or an “SRIS only” clock topology) that does not include the common clock buffer 405. According to either configuration (e.g., the first configuration, the second configuration, or both), one or more input-output signal lines may be connected directly between the memory system 110-c and the host systems 105, such as the clock request signal CLK REQ #. For example, all CLK REQ # signals may be coupled or “tied” together (e.g., for requesting REFCLK and L1.PM states). Further, each host system 105 may be coupled with the memory system 110-c via a respective port reset (PERST) signal line (e.g., PERST 0, 1, 2, and 3 may couple the memory system 110-c with the host system 105-a, the host system 105-b, the host system 105-c, and the host system 105-d, respectively). In any case, the memory system 110-c may receive, as an input, a reference clock signal such as REFCLK0.

In accordance with the first configuration, the common clock buffer 405 may receive one or more inputs such as the clock request signal CLK REQ # and at least one reference clock signal (e.g., REFCLK0). In some cases, the common clock buffer 405 may not support a common clock (e.g., due to locality issues). In such cases, the common clock buffer 405 may receive an SRIS signal (e.g., instead of the clock request signal CLK REQ #). The common clock buffer 405 may output one or more signals, including one or more reference clock signals (e.g., REFCLK-H3, REFCLK-H2, REFCLK-H1, REFCLK-H0, REFCLK0, REFCLK1). The one or more reference clock signals output by the common clock buffer 405 may provide a clock input for each host system 105, the memory system 110-c, or both (e.g., as shown in FIG. 4). Accordingly, each host system 105 may operate according to a respective clock input from the common clock buffer 405 (e.g., the common clock buffer 405 may support synchronization of operations between the host systems 105 and the memory system 110-c).

In accordance with the second configuration, each host system 105 may receive a respective SRIS clock signal (e.g., the host system 105-a may receive the SRIS CLK0, the host system 105-b may receive the SRIS CLK1, and so on). Since the second configuration may not include the common clock buffer 405, each host system 105 may refrain from receiving a reference clock signal (e.g., REFCLK-H0, REFCLK-H1, and so on). In some implementations, each host system 105 may refrain from applying the reference clock signal (e.g., from the common clock buffer 405).

The memory system 110-c may communicate with a baseboard management controller (BMC) (e.g., via an SMBus or one or more other signal lines). In some cases, the memory system 110-c may use the SMBus to manage device PCIe link subdivision settings via one or more NVMe commands (e.g., at a system setup time). Such settings may persist through power cycles of the memory system 110-c. Similarly, each host system 105 may communicate with the BMC (e.g., via a respective PERST signal line). Accordingly, the BMC may be a between-node between the memory system 110-c and the host systems 105, in some cases.

TABLE 2
Form Factor Clocking Architecture Specifications

| | Clock | PCIe 1.x, 2.x, 3.x | | PCIe 4.0 | PCIe 4.0 |
|---|---|---|---|---|---|
| Port | Architecture | Adapter | Platform | Platform | Adapter |
| Port0 | Common Clock | Used | Used | Optional | Used |
| | SRNS | N/A | N/A | Optional | Optional |
| | SRIS | N/A | N/A | Used if SRIS | Optional |
| | | | | supported | |
| Ports | Common Clock | N/A | N/A | N/A | N/A |
| 1 thru | SRNS | Optional | Optional | Optional | Optional |
| 3 | SRIS | Used | Used | Used | Used |

TABLE 3
Common Clock Architecture Details

| | Clock | PCIe 1.x, 2.x, 3.x | | PCIe 4.0 | PCIe 4.0 |
|---|---|---|---|---|---|
| Port | Architecture | Adapter | Platform | Platform | Adapter |
| Port0 | Clock | Used | Not Supported | Used | Not |
| | Source | | | | Supported |
| | SSC | Optional | N/A | Optional | N/A |
| | CLK REQ# | Optional | Optional | Optional | Optional |
| Ports | Clock | Used | Not Supported | Used | Not |
| 1 thru | Source | | | | Supported |
| 3 | SSC | Optional | N/A | Optional | N/A |
| | CLK REQ# | Optional | Optional | Optional | Optional |

Table 2 illustrates an example of one or more clocking architectures that may be used for different PCIe platforms and adapters as described herein. For example, Table 2 indicates, for each PCIe platform or adapter of an example set, whether a common clock, an SRNS, or an SRIS may be optional or used (e.g., required). Table 3 illustrates an example of clocking architecture details that may be optional, used (e.g., required), or not supported (e.g., not allowed) for a given port and PCIe adapter or platform. In any case, a timer for each port may be configured based on an implementation of the memory system 110-c or a host system 105. “N/A” may indicate that a clock architecture may be “not applicable” for a given adapter or platform.

In some implementations, the memory system 110-c may receive a clocking configuration for operation of the ports of the memory system 110-c. The memory system 110-c may communicate signaling with two or more host systems 105 (e.g., the host system 105-a and the host system 105-b) via two or more ports of the memory system 110-c in accordance with the clocking configuration. The clocking configuration may support separate clock signals (e.g., SRIS or SRNS) for the two or more ports. Accordingly, the memory system 110-c may operate a first port of the two or more ports (e.g., port 0) according to a first link state and a second port of the two or more ports (e.g., port 1) according to a second link state (e.g., if the clocking configuration supports separate clock signals for the two or more ports). The first link state and the second link state may correspond to link states described herein with reference to FIG. 3. In some cases, the clocking configuration may enable automatic detection of a reference clock at the ports of the memory system 110-c.

In some implementations, the memory system 110-c may assert, in accordance with the clocking configuration, a clock request signal that indicates a request for a common (e.g., shared) clock signal for each port of the memory system 110-c. Accordingly, the memory system 110-c may exchange signaling with the two or more host systems 105 in accordance with the common clock signal (e.g., based on asserting the clock request signal). In some examples, the memory system 110-c may transmit, by a management port of the memory system 110-c, the clock request signal to the common clock buffer 405. The clock request signal may enable the common clock signal for each port of the memory system 110-c.

In some cases, the memory system 110-c may determine to switch at least the second port from the first link state to the second link state in accordance with second signaling received at the second port, an idle time of the second port, or both. In response, the memory system 110-c may de-assert the clock request signal. The common clock signal may be disabled in response to the clock request signal being de-asserted. In such cases, The memory system 110-c may operate the first port according to the first link state and the second port according to the second link state in accordance with the common clock signal being disabled in response to de-asserting the clock request signal. Additionally, or alternatively, in response to determining to switch the second port to the second link state, the memory system 110-c may disable the common clock signal for the second port. In any case, the common clock signal may remain enabled for the other ports of the memory system 110-c (including the first port). In some examples, the memory system 110-c may operate the first port according to the first link state and the second port according to the second link state in accordance with disabling the common clock signal for the second port.

In some implementations, the memory system 110-c may communicate, by each port of the plurality of ports, via a respective link according to a respective clock source (e.g., corresponding to each port). The clocking configuration may enable separate reference clocks (e.g., SRIS) for each of the ports of the memory system 110-c. In some examples, the memory system 110-c may monitor, by at least the first port, for a common (e.g., shared) reference clock signal. In some cases, the memory system 110-c may fail to detect the common reference clock signal. In such cases, the memory system 110-c may operate the first port using a respective reference clock signal, different from the common reference clock signal, based on failing to detect the common reference clock signal. Additionally, or alternatively, the memory system 110-c may receive, by at least the first port, second signaling that disables automatic detection of a reference clock for the first port. Accordingly, the first port may communicate via a first link according to a first clock source for the first port in accordance with the signaling that disables the automatic detection of the reference clock (and irrespective of a common reference clock signal detected by the first port). In some cases, the memory system 110-c may enable SSC for the ports based on the clocking configuration enabling the separate reference clocks. Additionally, or alternatively, the memory system 110-c may disable SSC for at least one port based on a host system 105 associated with the at least one port supporting an SRIS.

The clock management techniques (e.g., topologies, configurations, implementations) described herein may result in one or more technical advantages and improvements. For example, using a common reference clock as described herein may result in relatively low cost systems (e.g., PLL systems) and may reduce a cost to build PCIe physical layers. Further, the techniques described herein may accommodate systems that may not support SRIS independent clocking. These clock management techniques may also improve clocking reliability and efficiency using a common system clock buffer, flexible PLLs (e.g., in a memory system controller), and reference clock configuration commands (e.g., reference clock autodetection commands, reference clock termination commands and so on). Moreover, SRIS operation using multiple ports (e.g., quad port SRIS operation) may result in flexible system operation for systems using different clock domains. To support SRIS operation using multiple ports, the techniques described herein may include PCIe physical layer support for SRIS (e.g., at up to a 4×1 link level) and one or more commands to control SSC (e.g., enabling and disabling SSC) for SRIS or SRNS.

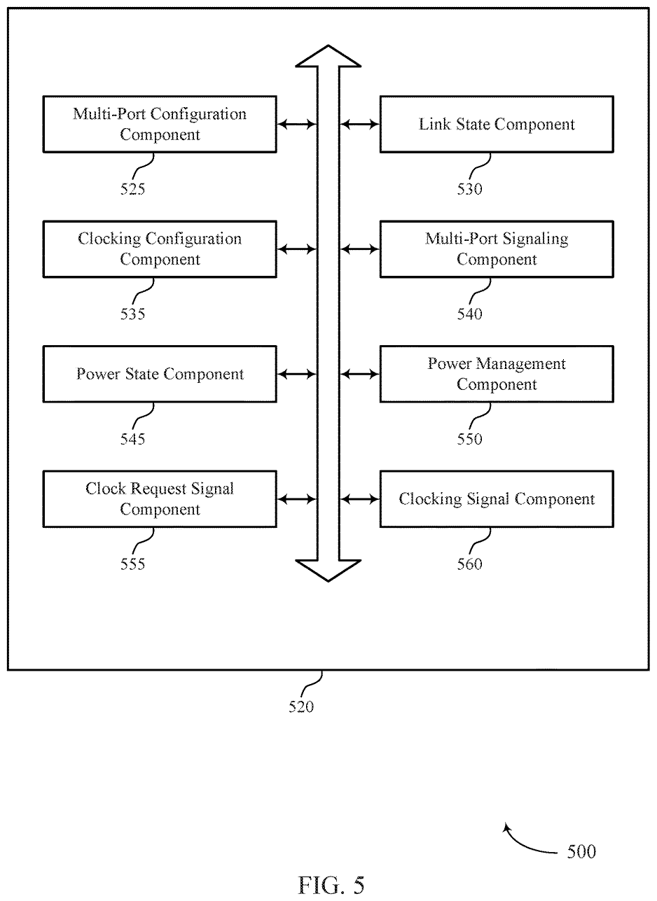

FIG. 5 shows a block diagram 500 of a memory system 520 that supports low power management and clock management within a multi-port memory system in accordance with examples as disclosed herein. The memory system 520 may be an example of aspects of a memory system as described with reference to FIGS. 1 through 4. The memory system 520, or various components thereof, may be an example of means for performing various aspects of low power management and clock management within a multi-port memory system as described herein. For example, the memory system 520 may include a multi-port configuration component 525, a link state component 530, a clocking configuration component 535, a multi-port signaling component 540, a power state component 545, a power management component 550, a clock request signal component 555, a clocking signal component 560, or any combination thereof. Each of these components, or components of subcomponents thereof (e.g., one or more processors, one or more memories), may communicate, directly or indirectly, with one another (e.g., via one or more buses).

The multi-port configuration component 525 may be configured as or otherwise support a means for receiving a configuration for operation of a plurality of ports of the memory system according to a plurality of link states, where each port of the plurality of ports of the memory system is configured for communication via a respective link. The link state component 530 may be configured as or otherwise support a means for operating, based at least in part on the configuration, each port of the plurality of ports according to a respective first link state of the plurality of link states indicated via the configuration, where each respective first link state corresponds to a first operation state of the memory system and a first power level of the memory system. In some examples, the link state component 530 may be configured as or otherwise support a means for transitioning, based at least in part on the configuration, one or more ports of the plurality of ports to one or more respective second link states of the plurality of link states, where each of the one or more respective second link states corresponds to the first operation state or a second operation state of the memory system, and where each of the one or more respective second link states is associated with a respective second power level of the memory system that is less than the first power level.

In some examples, the power state component 545 may be configured as or otherwise support a means for receiving, by a management port of the memory system, a management command that indicates a power state for at least the one or more ports of the plurality of ports, where transitioning the one or more ports to the one or more respective second link states is based at least in part on the power state indicated via the management command.

In some examples, to support transitioning the one or more ports to the one or more respective second link states, the link state component 530 may be configured as or otherwise support a means for transitioning each port of the plurality of ports to the one or more respective second link states based at least in part on the management command indicating a low power link state for at least one port, where the one or more respective second link states include low power management link states associated with the second operation state of the memory system and the respective second power level that is less than the first power level.

In some examples, to support transitioning the one or more ports to the one or more respective second link states, the link state component 530 may be configured as or otherwise support a means for transitioning each port of the plurality of ports to the one or more respective second link states based at least in part on an idle time of the plurality of ports exceeding a threshold idle time, where the one or more respective second link states include low power management link states associated with the second operation state of the memory system and the respective second power level that is less than the first power level.

In some examples, the link state component 530 may be configured as or otherwise support a means for periodically performing a plurality of link state transitions to transition the plurality of ports between the plurality of link states in accordance with an autonomous power state transition sequence, where the plurality of link state transitions are performed in response to an idle time of the plurality of ports exceeding a threshold idle time.

In some examples, the power management component 550 may be configured as or otherwise support a means for receiving, by a management port of the memory system and from a first host system of a plurality of host systems coupled with the memory system, a first command to disable power management for at least a first port of the plurality of ports that is coupled with the first host system based at least in part on the first host system powering off. In some examples, the link state component 530 may be configured as or otherwise support a means for transitioning at least the first port to a third link state associated with disabled power management in response to the first command. In some examples, the power management component 550 may be configured as or otherwise support a means for receiving, by the management port and from the first host system, a second command to re-enable the power management for at least the first port based at least in part on the first host system powering on. In some examples, the link state component 530 may be configured as or otherwise support a means for transitioning at least the first port to a respective first link state in response to the second command, the respective first link state associated with the first operation state, the first power level, and enabled power management.

In some examples, the link state component 530 may be configured as or otherwise support a means for operating, after transitioning the one or more ports to the one or more respective second link states, one or more remaining ports of the plurality of ports according to the respective first link state corresponding to the first operation state and the first power level.

In some examples, each of the one or more respective second link states is associated with a disabled reference clock and a disabled separate reference clock with independent spread.

In some examples, the first operation state includes an operational state associated with a full power state, a throttled power state or any both.

In some examples, the second operation state includes a non-operational state associated with an idle state, a low power state, a no-power state, or any combination thereof.

The clocking configuration component 535 may be configured as or otherwise support a means for receiving a clocking configuration for operation of a plurality of ports of the memory system, each port of the plurality of ports coupled with a respective host system. The multi-port signaling component 540 may be configured as or otherwise support a means for communicating signaling with two or more host systems via two or more ports of the plurality of ports in accordance with the clocking configuration. In some examples, the link state component 530 may be configured as or otherwise support a means for operating a first port of the two or more ports according to a first link state and a second port of the two or more ports according to a second link state in accordance with the clocking configuration supporting separate clock signals for the first port and for the second port.

In some examples, the clock request signal component 555 may be configured as or otherwise support a means for asserting, in accordance with the clocking configuration, a clock request signal that indicates a request for a common clock signal for each port of the plurality of ports, where exchanging the signaling with the two or more host systems is in accordance with the common clock signal based at least in part on asserting the clock request signal.

In some examples, the link state component 530 may be configured as or otherwise support a means for determining to switch at least the second port from the first link state to the second link state in accordance with second signaling received at the second port, an idle time of the second port, or both. In some examples, the clock request signal component 555 may be configured as or otherwise support a means for de-asserting, in response to determining to switch the second port to the second link state, the clock request signal, where operating the first port according to the first link state and the second port according to the second link state is in accordance with the common clock signal being disabled in response to de-asserting the clock request signal.

In some examples, to support asserting the clock request signal, the clock request signal component 555 may be configured as or otherwise support a means for transmitting, by a management port of the memory system, the clock request signal to a common clock buffer of the memory system, where the clock request signal enables the common clock signal for each port of the plurality of ports.

In some examples, the link state component 530 may be configured as or otherwise support a means for determining to switch at least the second port from the first link state to the second link state in accordance with second signaling received by the second port, an idle time of the second port, or both. In some examples, the clocking signal component 560 may be configured as or otherwise support a means for disabling, by the second port in response to determining to switch the second port to the second link state, the common clock signal for the second port, where the common clock signal remains enabled for other ports of the plurality of ports, including the first port, and where operating the first port according to the first link state and the second port according to the second link state is in accordance with disabling the common clock signal for the second port.

In some examples, the multi-port signaling component 540 may be configured as or otherwise support a means for communicating, by each port of the plurality of ports, via a respective link according to a respective clock source, where the clocking configuration enables separate reference clocks for each of the plurality of ports.

In some examples, the clocking signal component 560 may be configured as or otherwise support a means for monitoring, by at least the first port of the plurality of ports, for a common reference clock signal. In some examples, the clocking signal component 560 may be configured as or otherwise support a means for operating the first port using a respective reference clock signal, different from the common reference clock signal, based at least in part on failing to detect the common reference clock signal.

In some examples, the clocking signal component 560 may be configured as or otherwise support a means for receiving, by at least the first port of the plurality of ports, second signaling that disables automatic detection of a reference clock for the first port, where the first port communicates via a first link according to a first clock source for the first port in accordance with the signaling that disables the automatic detection of the reference clock and irrespective of a common reference clock signal detected by the first port.

In some examples, the clocking signal component 560 may be configured as or otherwise support a means for enabling spread spectrum clocking for the plurality of ports based at least in part on the clocking configuration enabling the separate reference clocks.

In some examples, the clocking signal component 560 may be configured as or otherwise support a means for disabling spread spectrum clocking for at least one port of the plurality of ports based at least in part on a host system associated with the at least one port supporting a separate reference clock with independent spread spectrum clocking.

In some examples, the clocking configuration enables automatic detection of a reference clock at the plurality of ports.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

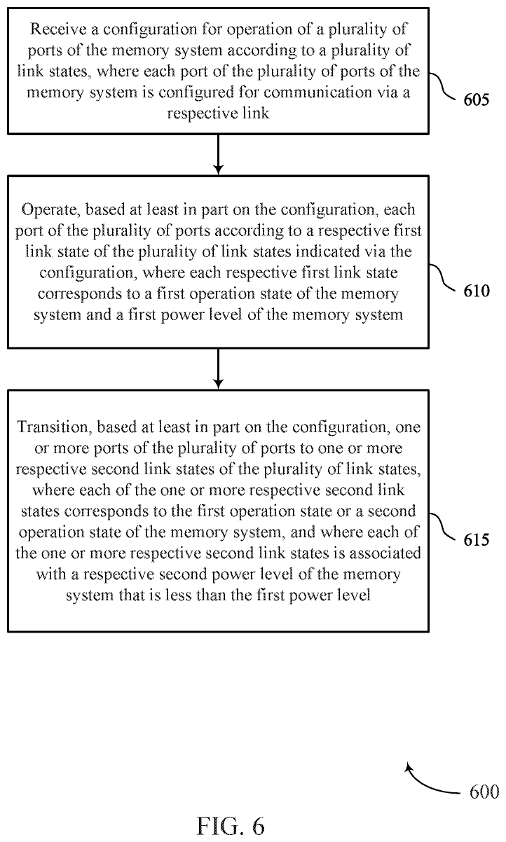

FIG. 6 shows a flowchart illustrating a method 600 that supports low power management and clock management within a multi-port memory system in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving a configuration for operation of a plurality of ports of the memory system according to a plurality of link states, where each port of the plurality of ports of the memory system is configured for communication via a respective link. In some examples, aspects of the operations of 605 may be performed by a multi-port configuration component 525 as described with reference to FIG. 5.

At 610, the method may include operating, based at least in part on the configuration, each port of the plurality of ports according to a respective first link state of the plurality of link states indicated via the configuration, where each respective first link state corresponds to a first operation state of the memory system and a first power level of the memory system. In some examples, aspects of the operations of 610 may be performed by a link state component 530 as described with reference to FIG. 5.

At 615, the method may include transitioning, based at least in part on the configuration, one or more ports of the plurality of ports to one or more respective second link states of the plurality of link states, where each of the one or more respective second link states corresponds to the first operation state or a second operation state of the memory system, and where each of the one or more respective second link states is associated with a respective second power level of the memory system that is less than the first power level. In some examples, aspects of the operations of 615 may be performed by a link state component 530 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a configuration for operation of a plurality of ports of the memory system according to a plurality of link states, where each port of the plurality of ports of the memory system is configured for communication via a respective link; operating, based at least in part on the configuration, each port of the plurality of ports according to a respective first link state of the plurality of link states indicated via the configuration, where each respective first link state corresponds to a first operation state of the memory system and a first power level of the memory system; and transitioning, based at least in part on the configuration, one or more ports of the plurality of ports to one or more respective second link states of the plurality of link states, where each of the one or more respective second link states corresponds to the first operation state or a second operation state of the memory system, and where each of the one or more respective second link states is associated with a respective second power level of the memory system that is less than the first power level.

Aspect 2: The method, apparatus, or non-transitory computer-readable medium of aspect 1, further including operations, features, circuitry, logic, means, or instructions, or any combination thereof for receiving, by a management port of the memory system, a management command that indicates a power state for at least the one or more ports of the plurality of ports, where transitioning the one or more ports to the one or more respective second link states is based at least in part on the power state indicated via the management command.

Aspect 3: The method, apparatus, or non-transitory computer-readable medium of aspect 2, where transitioning the one or more ports to the one or more respective second link states includes operations, features, circuitry, logic, means, or instructions, or any combination thereof for transitioning each port of the plurality of ports to the one or more respective second link states based at least in part on the management command indicating a low power link state for at least one port, where the one or more respective second link states include low power management link states associated with the second operation state of the memory system and the respective second power level that is less than the first power level.

Aspect 4: The method, apparatus, or non-transitory computer-readable medium of any of aspects 1 through 3, where transitioning the one or more ports to the one or more respective second link states includes operations, features, circuitry, logic, means, or instructions, or any combination thereof for transitioning each port of the plurality of ports to the one or more respective second link states based at least in part on an idle time of the plurality of ports exceeding a threshold idle time, where the one or more respective second link states include low power management link states associated with the second operation state of the memory system and the respective second power level that is less than the first power level.

Aspect 5: The method, apparatus, or non-transitory computer-readable medium of any of aspects 1 through 4, further including operations, features, circuitry, logic, means, or instructions, or any combination thereof for periodically performing a plurality of link state transitions to transition the plurality of ports between the plurality of link states in accordance with an autonomous power state transition sequence, where the plurality of link state transitions are performed in response to an idle time of the plurality of ports exceeding a threshold idle time.

Aspect 6: The method, apparatus, or non-transitory computer-readable medium of any of aspects 1 through 5, further including operations, features, circuitry, logic, means, or instructions, or any combination thereof for receiving, by a management port of the memory system and from a first host system of a plurality of host systems coupled with the memory system, a first command to disable power management for at least a first port of the plurality of ports that is coupled with the first host system based at least in part on the first host system powering off; transitioning at least the first port to a third link state associated with disabled power management in response to the first command; receiving, by the management port and from the first host system, a second command to re-enable the power management for at least the first port based at least in part on the first host system powering on; and transitioning at least the first port to a respective first link state in response to the second command, the respective first link state associated with the first operation state, the first power level, and enabled power management.

Aspect 7: The method, apparatus, or non-transitory computer-readable medium of any of aspects 1 through 6, further including operations, features, circuitry, logic, means, or instructions, or any combination thereof for operating, after transitioning the one or more ports to the one or more respective second link states, one or more remaining ports of the plurality of ports according to the respective first link state corresponding to the first operation state and the first power level.

Aspect 8: The method, apparatus, or non-transitory computer-readable medium of any of aspects 1 through 7, where each of the one or more respective second link states is associated with a disabled reference clock and a disabled separate reference clock with independent spread.

Aspect 9: The method, apparatus, or non-transitory computer-readable medium of any of aspects 1 through 8, where the first operation state includes an operational state associated with a full power state, a throttled power state or any both.

Aspect 10: The method, apparatus, or non-transitory computer-readable medium of any of aspects 1 through 9, where the second operation state includes a non-operational state associated with an idle state, a low power state, a no-power state, or any combination thereof.

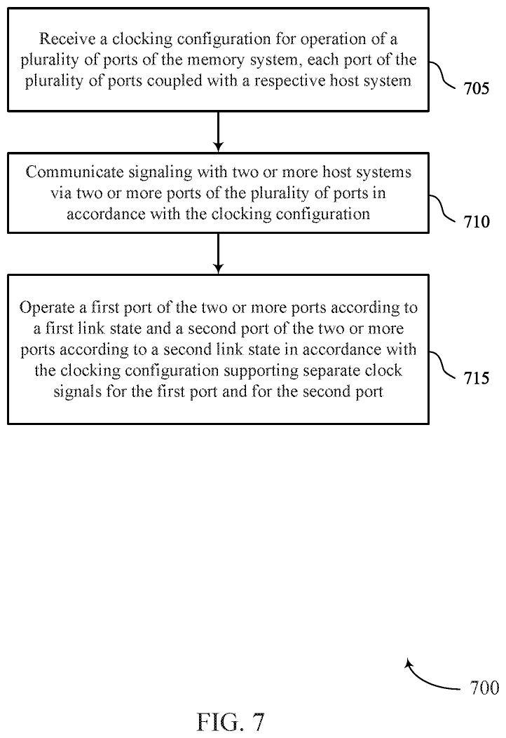

FIG. 7 shows a flowchart illustrating a method 700 that supports low power management and clock management within a multi-port memory system in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include receiving a clocking configuration for operation of a plurality of ports of the memory system, each port of the plurality of ports coupled with a respective host system. In some examples, aspects of the operations of 705 may be performed by a clocking configuration component 535 as described with reference to FIG. 5.

At 710, the method may include communicating signaling with two or more host systems via two or more ports of the plurality of ports in accordance with the clocking configuration. In some examples, aspects of the operations of 710 may be performed by a multi-port signaling component 540 as described with reference to FIG. 5.

At 715, the method may include operating a first port of the two or more ports according to a first link state and a second port of the two or more ports according to a second link state in accordance with the clocking configuration supporting separate clock signals for the first port and for the second port. In some examples, aspects of the operations of 715 may be performed by a link state component 530 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 11: A method, apparatus, or non-transitory computer-readable medium including operations, features, circuitry, logic, means, or instructions, or any combination thereof for receiving a clocking configuration for operation of a plurality of ports of the memory system, each port of the plurality of ports coupled with a respective host system; communicating signaling with two or more host systems via two or more ports of the plurality of ports in accordance with the clocking configuration; and operating a first port of the two or more ports according to a first link state and a second port of the two or more ports according to a second link state in accordance with the clocking configuration supporting separate clock signals for the first port and for the second port.

Aspect 12: The method, apparatus, or non-transitory computer-readable medium of aspect 11, further including operations, features, circuitry, logic, means, or instructions, or any combination thereof for asserting, in accordance with the clocking configuration, a clock request signal that indicates a request for a common clock signal for each port of the plurality of ports, where exchanging the signaling with the two or more host systems is in accordance with the common clock signal based at least in part on asserting the clock request signal.

Aspect 13: The method, apparatus, or non-transitory computer-readable medium of aspect 12, further including operations, features, circuitry, logic, means, or instructions, or any combination thereof for determining to switch at least the second port from the first link state to the second link state in accordance with second signaling received at the second port, an idle time of the second port, or both and de-asserting, in response to determining to switch the second port to the second link state, the clock request signal, where operating the first port according to the first link state and the second port according to the second link state is in accordance with the common clock signal being disabled in response to de-asserting the clock request signal.

Aspect 14: The method, apparatus, or non-transitory computer-readable medium of any of aspects 12 through 13, where asserting the clock request signal includes operations, features, circuitry, logic, means, or instructions, or any combination thereof for transmitting, by a management port of the memory system, the clock request signal to a common clock buffer of the memory system, where the clock request signal enables the common clock signal for each port of the plurality of ports.

Aspect 15: The method, apparatus, or non-transitory computer-readable medium of any of aspects 12 through 14, further including operations, features, circuitry, logic, means, or instructions, or any combination thereof for determining to switch at least the second port from the first link state to the second link state in accordance with second signaling received by the second port, an idle time of the second port, or both and disabling, by the second port in response to determining to switch the second port to the second link state, the common clock signal for the second port, where the common clock signal remains enabled for other ports of the plurality of ports, including the first port, and where operating the first port according to the first link state and the second port according to the second link state is in accordance with disabling the common clock signal for the second port.

Aspect 16: The method, apparatus, or non-transitory computer-readable medium of any of aspects 11 through 15, further including operations, features, circuitry, logic, means, or instructions, or any combination thereof for communicating, by each port of the plurality of ports, via a respective link according to a respective clock source, where the clocking configuration enables separate reference clocks for each of the plurality of ports.

Aspect 17: The method, apparatus, or non-transitory computer-readable medium of aspect 16, further including operations, features, circuitry, logic, means, or instructions, or any combination thereof for monitoring, by at least the first port of the plurality of ports, for a common reference clock signal and operating the first port using a respective reference clock signal, different from the common reference clock signal, based at least in part on failing to detect the common reference clock signal.

Aspect 18: The method, apparatus, or non-transitory computer-readable medium of any of aspects 16 through 17, further including operations, features, circuitry, logic, means, or instructions, or any combination thereof for receiving, by at least the first port of the plurality of ports, second signaling that disables automatic detection of a reference clock for the first port, where the first port communicates via a first link according to a first clock source for the first port in accordance with the signaling that disables the automatic detection of the reference clock and irrespective of a common reference clock signal detected by the first port.

Aspect 19: The method, apparatus, or non-transitory computer-readable medium of any of aspects 16 through 18, further including operations, features, circuitry, logic, means, or instructions, or any combination thereof for enabling spread spectrum clocking for the plurality of ports based at least in part on the clocking configuration enabling the separate reference clocks.

Aspect 20: The method, apparatus, or non-transitory computer-readable medium of any of aspects 16 through 19, further including operations, features, circuitry, logic, means, or instructions, or any combination thereof for disabling spread spectrum clocking for at least one port of the plurality of ports based at least in part on a host system associated with the at least one port supporting a separate reference clock with independent spread spectrum clocking.

Aspect 21: The method, apparatus, or non-transitory computer-readable medium of any of aspects 11 through 20, where the clocking configuration enables automatic detection of a reference clock at the plurality of ports.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The term “layer” or “level” used herein refers to a stratum or sheet of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin-film. Layers or levels may include different elements, components, and/or materials. In some examples, one layer or level may be composed of two or more sublayers or sublevels.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a configuration for operation of a plurality of ports of the memory system according to a plurality of link states, wherein each port of the plurality of ports of the memory system is configured for communication via a respective link;
operate, based at least in part on the configuration, each port of the plurality of ports according to a respective first link state of the plurality of link states indicated via the configuration, wherein each respective first link state corresponds to a first operation state of the memory system and a first power level of the memory system; and
transition, based at least in part on the configuration, one or more ports of the plurality of ports to one or more respective second link states of the plurality of link states, wherein each of the one or more respective second link states corresponds to the first operation state or a second operation state of the memory system, and wherein each of the one or more respective second link states is associated with a respective second power level of the memory system that is less than the first power level.

2. The memory system of claim 1, wherein the processing circuitry is further configured to cause the memory system to:
receive, by a management port of the memory system, a management command that indicates a power state for at least the one or more ports of the plurality of ports, wherein transitioning the one or more ports to the one or more respective second link states is based at least in part on the power state indicated via the management command.

3. The memory system of claim 2, wherein, to transition the one or more ports to the one or more respective second link states, the processing circuitry is configured to cause the memory system to:
transition each port of the plurality of ports to the one or more respective second link states based at least in part on the management command indicating a low power link state for at least one port, wherein the one or more respective second link states comprise low power management link states associated with the second operation state of the memory system and the respective second power level that is less than the first power level.

4. The memory system of claim 1, wherein, to transition the one or more ports to the one or more respective second link states, the processing circuitry is configured to cause the memory system to:
transition each port of the plurality of ports to the one or more respective second link states based at least in part on an idle time of the plurality of ports exceeding a threshold idle time, wherein the one or more respective second link states comprise low power management link states associated with the second operation state of the memory system and the respective second power level that is less than the first power level.

5. The memory system of claim 1, wherein the processing circuitry is further configured to cause the memory system to:
periodically perform a plurality of link state transitions to transition the plurality of ports between the plurality of link states in accordance with an autonomous power state transition sequence, wherein the plurality of link state transitions are performed in response to an idle time of the plurality of ports exceeding a threshold idle time.

6. The memory system of claim 1, wherein the processing circuitry is further configured to cause the memory system to:
receive, by a management port of the memory system and from a first host system of a plurality of host systems coupled with the memory system, a first command to disable power management for at least a first port of the plurality of ports that is coupled with the first host system based at least in part on the first host system powering off;
transition at least the first port to a third link state associated with disabled power management in response to the first command;
receive, by the management port and from the first host system, a second command to re-enable the power management for at least the first port based at least in part on the first host system powering on; and
transition at least the first port to a respective first link state in response to the second command, the respective first link state associated with the first operation state, the first power level, and enabled power management.

7. The memory system of claim 1, wherein the processing circuitry is further configured to cause the memory system to:
operate, after transitioning the one or more ports to the one or more respective second link states, one or more remaining ports of the plurality of ports according to the respective first link state corresponding to the first operation state and the first power level.

8. The memory system of claim 1, wherein each of the one or more respective second link states is associated with a disabled reference clock and a disabled separate reference clock with independent spread.

9. The memory system of claim 1, wherein the first operation state comprises an operational state associated with a full power state, a throttled power state or any both.

10. The memory system of claim 1, wherein the second operation state comprises a non-operational state associated with an idle state, a low power state, a no-power state, or any combination thereof.

11. A method by a memory system, comprising:
receiving a configuration for operation of a plurality of ports of the memory system according to a plurality of link states, wherein each port of the plurality of ports of the memory system is configured for communication via a respective link;
operating, based at least in part on the configuration, each port of the plurality of ports according to a respective first link state of the plurality of link states indicated via the configuration, wherein each respective first link state corresponds to a first operation state of the memory system and a first power level of the memory system; and
transitioning, based at least in part on the configuration, one or more ports of the plurality of ports to one or more respective second link states of the plurality of link states, wherein each of the one or more respective second link states corresponds to the first operation state or a second operation state of the memory system, and wherein each of the one or more respective second link states is associated with a respective second power level of the memory system that is less than the first power level.

12. The method of claim 11, further comprising:
receiving, by a management port of the memory system, a management command that indicates a power state for at least the one or more ports of the plurality of ports, wherein transitioning the one or more ports to the one or more respective second link states is based at least in part on the power state indicated via the management command.

13. The method of claim 11, wherein transitioning the one or more ports to the one or more respective second link states comprises:
transitioning each port of the plurality of ports to the one or more respective second link states based at least in part on an idle time of the plurality of ports exceeding a threshold idle time, wherein the one or more respective second link states comprise low power management link states associated with the second operation state of the memory system and the respective second power level that is less than the first power level.

14. The method of claim 11, further comprising:
periodically performing a plurality of link state transitions to transition the plurality of ports between the plurality of link states in accordance with an autonomous power state transition sequence, wherein the plurality of link state transitions are performed in response to an idle time of the plurality of ports exceeding a threshold idle time.

15. The method of claim 11, further comprising:
receiving, by a management port of the memory system and from a first host system of a plurality of host systems coupled with the memory system, a first command to disable power management for at least a first port of the plurality of ports that is coupled with the first host system based at least in part on the first host system powering off;
transitioning at least the first port to a third link state associated with disabled power management in response to the first command;
receiving, by the management port and from the first host system, a second command to re-enable the power management for at least the first port based at least in part on the first host system powering on; and
transitioning at least the first port to a respective first link state in response to the second command, the respective first link state associated with the first operation state, the first power level, and enabled power management.

16. The method of claim 11, further comprising:
operating, after transitioning the one or more ports to the one or more respective second link states, one or more remaining ports of the plurality of ports according to the respective first link state corresponding to the first operation state and the first power level.

17. The method of claim 11, wherein each of the one or more respective second link states is associated with a disabled reference clock and a disabled separate reference clock with independent spread.

18. A non-transitory computer-readable medium storing code comprising instructions which, when executed by one or more processors of a memory system, cause the memory system to:
receive a configuration for operation of a plurality of ports of the memory system according to a plurality of link states, wherein each port of the plurality of ports of the memory system is configured for communication via a respective link;
operate, based at least in part on the configuration, each port of the plurality of ports according to a respective first link state of the plurality of link states indicated via the configuration, wherein each respective first link state corresponds to a first operation state of the memory system and a first power level of the memory system; and
transition, based at least in part on the configuration, one or more ports of the plurality of ports to one or more respective second link states of the plurality of link states, wherein each of the one or more respective second link states corresponds to the first operation state or a second operation state of the memory system, and wherein each of the one or more respective second link states is associated with a respective second power level of the memory system that is less than the first power level.

19. The non-transitory computer-readable medium of claim 18, wherein the instructions, when executed by the one or more processors of the memory system, further cause the memory system to:
receive, by a management port of the memory system, a management command that indicates a power state for at least the one or more ports of the plurality of ports, wherein transitioning the one or more ports to the one or more respective second link states is based at least in part on the power state indicated via the management command.

20. The non-transitory computer-readable medium of claim 18, wherein the instructions to transition the one or more ports to the one or more respective second link states, when executed by the one or more processors of the memory system, cause the memory system to:
transition each port of the plurality of ports to the one or more respective second link states based at least in part on an idle time of the plurality of ports exceeding a threshold idle time, wherein the one or more respective second link states comprise low power management link states associated with the second operation state of the memory system and the respective second power level that is less than the first power level.
